(19) United States
(12) Patent Application Publication
(10) Pub. No.: US 2008/0178738 A1
(43) Pub. Date: Jul. 31, 2008

(54) Absorbent and/or filter materials comprising open cell foams coated with photocatalytic titanium dioxide, and methods of making and using the same

(75) Inventors: Chiu Y. Chan, Wilmington, DE (US); Xingwu Wang, Chapel Hill, NC (US)

Correspondence Address: Connolly Bove Lodge & Hutz LLP, 1007 North Orange Street, P.O. Box 2207, Wilmington, DE, 19899, US

(73) Assignee: FOAMEX L.P., Linwood, PA (US)

(21) Appl. No.: 11/699,098

(22) Filed: Jan. 29, 2007

(51) Int. Cl. B01J 21/06; B01D 15/00; B01D 53/14

(52) U.S. Cl. 95/141; 210/679; 502/350; 95/90

(57) ABSTRACT

Filter and/or absorbent materials comprising an open cell foam having a surface, wherein the surface of the open cell foam is at least partially coated with a layer comprising photocatalytic titanium dioxide; methods for making such materials comprising: (a) providing a mixture comprising photocatalytic titanium dioxide in a binder; (b) immersing an open cell foam article in the mixture; (c) removing the article from the mixture and removing excess mixture from the article; and methods of treating gases or liquids by passing the gas or liquid through such a material wherein the material has been activated by UV radiation are described.

### BACKGROUND OF THE INVENTION

Titanium dioxide, or titania (TiO₂), is a metal oxide which occurs naturally, for example, in various ores. Titanium dioxide is known to have photocatalytic properties. When activated by ultra-violet (UV) radiation, photocatalytic titanium dioxide undergoes electron band gap transitions which result in the interaction of positive “holes” with water absorbed on the surface of the titania to form hydroxyl radicals. The hydroxyl radicals are powerful oxidizers which act to decompose organic matter. Additionally, UV radiation can cause electrons in the titanium dioxide to form superoxide anions by reacting with oxygen in the air. The superoxide anions can then form peroxides.

Titanium dioxide occurs in three crystalline forms: rutile, brookite and anatase. The most common and least expensive form of titanium dioxide is rutile crystalline titania. Titanium dioxide having an anatase crystalline structure is known to be the most photocatalytically active form of titanium dioxide. Commercially available photocatalytic grade titania is comprised of anatase titania.

Within recent years, the use of photocatalytic titanium dioxide has grown in so-called “self-cleaning” applications. For example, photocatalytic titanium dioxide has been proposed for use in floor and wall tiles, and on aluminum siding to cause decomposition of bacteria and organic matter deposited on the surfaces thereof. Coatings of photocatalytic titanium dioxide on glass, for example as light cover for tunnel lighting, have also been proposed. The use of photocatalytic titanium dioxide has also been suggested for coatings on paper materials, window dressings and blinds, tents and other fabrics. In such proposed self-cleaning applications, a thin coating of titania is to be applied to an exposed surface but its effectiveness may be significantly limited by the amount of surface area exposed to UV light.

The use of open cell foams as absorbent materials, e.g., sponges, wipes, etc., and as filter media is known. In particular, polyurethane foam coated with activated carbon has been used for absorption of odors and hydrocarbon vapors. However, once the absorption capacity of the activated carbon is reached, absorption ceases.

The provision of absorbent materials and filter media which make effective use of photocatalytic titanium dioxide's properties, for example by maximizing exposed surface area, and which are not limited by the physical absorption capacity of an active ingredient would be desirable.

### BRIEF SUMMARY OF THE INVENTION

The present invention relates, in general, to open cell foams at least partly coated with photocatalytic titanium dioxide, their preparation and their use for treating liquids and gases, preferably air, to decompose or degrade various contaminants.

One embodiment of the present invention includes filters or absorbent materials which comprise an open cell foam having a surface, wherein the surface of the open cell foam is at least partially coated with a layer comprising photocatalytic titanium dioxide.

Another embodiment of the present invention includes methods of treating a gas or liquid, the methods comprising providing an open cell foam coated with photocatalytic titanium dioxide, and contacting a substance to be treated selected from the group consisting of liquids, gases and mixtures thereof, with the open cell foam such that the substance contacts the photocatalytic titanium dioxide, wherein the photocatalytic titanium dioxide is activated by a source of UV radiation.

Yet another embodiment of the present invention includes methods of preparing a filter or absorbent material, the methods comprising: (a) providing a mixture comprising photocatalytic titanium dioxide in a binder; (b) immersing an open cell foam article in the mixture; (c) removing the article from the mixture and removing excess mixture from the article.

In various preferred embodiments of the present invention, the open cell foam comprises a polyurethane. Additionally, in various preferred embodiments of the present invention, the open cell foam is coated, or more preferably impregnated, with photocatalytic titanium dioxide by an immersion process in which photocatalytic titanium dioxide is disposed in an essentially uniform manner over the entire surface of the open cell foam. While polyurethane foams are preferred, other foams, including polymeric, metallic and ceramic foams, as well as other porous substrates can be coated or impregnated with such a coating and used in accordance with various embodiments of the invention.

### DETAILED DESCRIPTION OF THE INVENTION

Filter materials and absorbent materials in accordance with various embodiments of the present invention comprise an open cell foam which is at least partially coated with photocatalytic titanium dioxide. Suitable open cell foams can be prepared from any polymeric closed cell foam. In certain preferred embodiments of the present invention, the foam comprises a polyurethane foam.

In general, polyurethane foams can be prepared by reacting a polyol with a polyisocyanate in the presence of a catalyst, and a blowing agent. One or more foam stabilizers and/or surfactants and/or other foaming aids may also optionally be included.

Polyols and methods for their preparation are known. In general, a “polyol” is an ingredient having at least two hydroxyl groups. The term “polyol” herein refers to any polyol that has previously been suggested for use or which may be developed for use in preparing polyurethane foams. Polyols suitable for use in the preparation of polyurethanes useful in the present invention include polyethers, polyesteramides, polythioethers, polycarbonates, polyacetals, polyolefins, polysiloxanes, various grades of caster oils, hydroxy-terminated prepolymers, and mixtures thereof. Suitable polyether polyols (or polyoxyalkylene polyols) can be prepared by reaction of any of the following polyhydroxy compounds with an alkylene oxide such as ethylene oxide, 1,2-propylene oxide, 1,3-propylene oxide, epichlorohydrin, epibromohydrin, 1,2-butene oxide and tetrahydrofuran. Suitable polyhydroxy compounds for reaction with the alkylene oxides include simple aliphatic polyols such as ethylene glycol, 1,2-propylene glycol, 1,3-butylene glycol, 2,3-butylene glycol, tetramethylene glycol, pentamethylene glycol, hexamethylene glycol, decamethylene glycol, 2,2-dimethyltrimethylene glycol, glycerin. Trimethylolethane, trimethylolpropane, pentaerythritol, sorbitol, 1,6-hexanediol, 1,2,6-hexanetriol, 2-ethyl-1,3-hexanediol, castor oil, polyvinyl alcohol and partially hydrolyzed polyvinyl acetate; carbohydrates containing 5 to 8 hydroxyl groups such as sucrose, dextrose, and methylglucoside, ether polyols such as diethylene glycol and dipropylene glycol; aromatic polyols such as diphenylene glycol; and mixtures thereof are also useful. These polyether polyols include polyethylene glycol and polytetramethylene ether glycol. Other suitable polyols include, for example, ethylene glycol, propylene glycol, diethylene glycol, dipropylene glycol, 1,4-butanediol, 1,6-hexanediol, hydroxy terminated prepolymers, glycerol, trimethylolpropane, 1,2,4-butanetriol, 1,2,6-hexanetriol and mixtures thereof.

The term “polyisocyanate” refers to isocyanates that have previously been suggested for use or which may be developed for use in preparing polyurethane foams. Polyisocyanates include di- and poly-isocyanates and prepolymers of polyols and polyisocyanates having excess isocyanate groups available to react with additional polyol. Polyisocyanates which may be used in preparing polyurethanes suitable for use in the present invention include aromatic, aliphatic, or cycloaliphatic polyisocyanates, and combinations thereof, such as, for example, m-phenylene diisocyanate, 2,4-toluene diisocyanate, 2,6-toluene diisocyanate, hexamethylene diisocyanate, tetramethylene diisocyanate, 1,4-cyclohexane diisocyanate, hexahydrotoluene diisocyanate, 1,5-naphthalene diisocyanate, 1-methoxy-2,4-phenylene diisocyanate, 4,4′-diphenylmethane diisocyanate, 2,4′-diphenylmenthane diisocyanate, 4,4′-biphenylene diisocyanate, 3,3′-dimethoxy-4,4′-biphenyl diisocyanate, 3,3′-dimethyl-4,4′-biphenyl diisocyanate, 3,3′-dimethyl-4,4′-diphenylmenthane diisocyanate, isophorone diisocyanate, 4,4′,4″triphenylmethane triisocyanate, polymethylene polyphenylene polyisocyanate, 2,4,6-toluene triisocyanate, 4,4′-dimethyl-diphenylmethane tetraisocyanate, and mixtures thereof.

Catalysts suitable for use in preparing polyurethanes for use in various embodiments of the present invention include amine catalysts, such as triethylene-diamine, imidazoles and tin catalysts, such as stannous octoate. Catalysts are preferably present in amounts from 0.1 to 1.0 parts by weight for amine catalyst, and 0 to 0.5 parts by weight for tin catalyst, based on 100 parts by weight of the polyol component. Other catalysts may be included in the foam-forming mixture, such as gel catalysts often used as replacements for tin catalysts, including zinc octoate or potassium octoate. Preferably, catalysts are incorporated in a pure or concentrated form to avoid introducing carriers or reactive carriers into the foam-forming mixture, which carriers may leave undesirable residuals in the resulting foam structure.

Any blowing agent known or to be developed can be used in the preparation of a polyurethane foam for use in the present invention. The most typical blowing agent is water, which is added in an amount suitable to achieve a desired foam density. In general, the density of the foam prepared for use in the present invention (prior to reticulation) is about 1-3 lb/ft³, and preferably about 1.4 to 2 lb/ft³. The amount may vary depending upon the operating pressure during foaming. In this invention, water is added as a blowing agent, typically in an amount of about below 1.0 parts by weight, preferably from 0.2 to 1.0 parts by weight, per 100 parts by weight of the polyol component. Water is the preferred blowing agent, but auxiliary blowing agents may be introduced into the foam-forming mixture in some circumstances.

One or more stabilizers or surfactants may also be included in the foam-forming composition. The surfactants can lower the bulk surface tension, promote nucleation of bubbles, stabilize the rising cellular structure and emulsify incompatible ingredients. Stabilizers suitable for use in the present invention include silicone foam stabilizers or surfactants, and may be present in amounts from 0.5 to 2.0 parts by weight, preferably from 0.5 to 1.0 parts by weight, based on 100 parts by weight of the polyol component.

Optionally, other additives may be incorporated into the foam-forming composition. The optional additives include, but are not limited to, anti-static agents, fire retardants, stabilizers, additional antimicrobial compounds, extender oils, dyes, and pigments. Such additives should not have a detrimental effect on the properties of the final polyurethane foam.

The polymeric foam material used to form the open-cell foam for use in the preparation of the titanium dioxide coated articles of the present invention is reticulated to remove or destroy the thin walls of polymer material between individual connected cells of the foam. The process of reticulation results in an open cell foam suitable for coating with titanium dioxide. Various methods of reticulation are known. For example, methods of reticulation employing alkali substances are disclosed in U.S. Pat. No. 3,125,542, U.S. Pat. No. 3,405,217 and U.S. Pat. No. 3,423,338, the entire contents of each of which are hereby incorporated herein by reference. Methods of reticulation employing physical stretching and deformation of a closed cell foam are described in U.S. Pat. No. 3,425,890, the entire contents of which are hereby incorporated herein by reference. Methods of reticulation employing combustible gases are disclosed in U.S. Pat. No. 3,175,025, the entire contents of which are hereby incorporated herein by reference. Also, methods of in-situ reticulation are described in U.S. Pat. No. 4,670,477, the entire contents of which are hereby incorporated herein by reference. Any method of reticulation known or to be developed which does not interfere with the coating of the foam material with titanium dioxide and which does not destroy the structural integrity of the foam such that it is unsuitable for use as an absorbent or filter material can be employed in the various embodiments of the present invention.

While it is preferable in accordance with various embodiments of the methods of preparing absorbent materials and filter media according to the invention to carry out reticulation of the closed cell foam material prior to applying a photocatalytic titanium dioxide layer, reticulation can optionally be carried out either prior to applying the titanium dioxide coating, after applying the titanium dioxide coating, or both before and after applying the titanium dioxide coating.

The photocatalytic titanium dioxide used in the present invention is, in general, any TiO₂ which exhibits greater photocatalytic activity than standard pigment grade TiO₂ comprised entirely of rutile titania. The photocatalytic titanium dioxide preferably comprises TiO₂ having an anatase crystalline structure.

In increasingly preferred embodiments of the present invention, the photocatalytic titanium dioxide comprises TiO₂ having an anatase crystalline structure in an amount greater than or equal to, in each case: 10%, 20%, 30%, 40%, 50%, 60%, 70%, 80%, 90%, 95% and most preferably 99% by weight, based on the total amount of titanium dioxide.

In various preferred embodiments of the present invention, the photocatalytic titanium dioxide can have an average particle size of less than about 100 nanometers. Such nanoscale titanium dioxide is available commercially, for example from Degussa AG (Essen, Germany) under the tradename designation P25, and can also be prepared from larger particle size titania by methods known in the literature.

In certain particularly preferred embodiments of the present invention, the photocatalytic titanium dioxide comprises TiO₂ having an anatase crystalline structure, and even more preferably in the increasingly larger amounts recited above, and further has an average particle size of less than about 100 nanometers.

The absorbent materials and filter materials according to various embodiments of the present invention are at least partially coated with photocatalytic titanium dioxide. The photocatalytic titanium dioxide is disposed on the surface of the foam in a layer. As used herein, the term “surface” refers to any or all of the exterior portions of a continuous open cell foam structure, including the surfaces of the cellular network in the internal portions of the foam material and the external (i.e., visible) surfaces of the foam. As used herein, the term “layer” can refer to a continuous or discontinuous deposition of the titanium dioxide of any thickness. The term “layer” as used herein does not require a cohesive, uninterrupted “blanket” of titanium dioxide. The layer of photocatalytic titanium dioxide can comprise discrete molecules, crystals, nanoparticles, agglomerates, etc. of photocatalytic titanium dioxide deposited on the surface(s) of the foam. In various preferred embodiments of the present invention, the deposition of photocatalytic titanium dioxide is substantially homogenous over the portions of the surface coated with the photocatalytic titanium dioxide. Substantially homogenous refers to a layer of photocatalytic titanium dioxide in which the amount per unit surface area does not vary more than +/−25% from one area of the foam surface to another.

In increasingly preferred embodiments of the present invention, the layer comprising photocatalytic titanium dioxide is disposed on at least: 10%, 20%, 30%, 40%, 50%, 60%, 70%, 80%, 90%, 95% and most preferably 99% of the total surface area of the foam material.

The present invention also includes methods of producing absorbent materials and filter materials according to the various embodiments described above. Methods of producing such absorbent/filter materials can include providing an open cell foam and immersing the open cell foam in a mixture (i.e., a coating formulation) comprising photocatalytic titanium dioxide and a binder.

Coating formulations suitable for use in embodiments according to the present invention can be aqueous or non-aqueous. Preferably, the coating formulation is aqueous. Coating formulations suitable for use in accordance with preferred embodiments of the present invention can include; in addition to a (preferably aqueous) mixture of photocatalytic titanium dioxide and a binder; a thickener, a surfactant, a defoamer and/or ammonium hydroxide. In various preferred embodiments, the coating formulation includes photocatalytic titanium dioxide, water, a binder; a thickener, a surfactant, and a defoamer. In various more preferred embodiments, the coating formulation includes those components wherein the binder, thickener, surfactant and defoamer are all nonionic.

Suitable coating formulations can be prepared by mixing the components together at room temperature and allowing the mixture to stand, for example, for about 20 minutes. Coating formulations suitable for use in the methods according to the invention generally have a viscosity of about 1000 to 5000 centipoise, and preferably about 3500 to 4000 centipoise. Viscosity can be measured by any technique or device known or to be developed for measuring viscosity. Preferably, in the preparation of a coating formulation, the components are added (where applicable) in the following order: titanium dioxide, water, ammonium hydroxide, defoamer, surfactant, binder and thickener.

Representative binders which may be used in processes according to the present invention include aqueous and non-aqueous binders, such as, for example, acrylic binders, acrylonitrile binders, epoxy binders, urethane binders, natural or synthetic rubbers, PVC emulsion binders, and/or a blend of various binders. Suitable binders are preferably aqueous. Suitable binders can preferably be nonionic. More preferably, a binder which is nonionic and aqueous is employed. A binder is typically employed in accordance with methods of the present invention in a titanium dioxide particle to binder ratio of about 20:1 to 1:5, preferably about 4:1 to 2:1. Suitable preferred binders include one or more aqueous binders, such as Rhoplex® HA-8, HA-12, HA-16, E-358, E-32NP and mixtures thereof, commercially available from Rohm & Haas Company.

A thickener can be included in a coating formulation for use in a method according to the present invention to help build up viscosity in the coating formulation to improve application to the foam and minimize drainage from the surface. Suitable preferred thickeners include one or more nonionic thickeners, such as, for example, Acrysol® RM-12W, RM-825, RM-830, RM-8, RM-175, RM-6000, RM-2020NPR and mixtures thereof, commercially available from Rohm & Haas Company.

A surfactant can be included in a coating formulation for use in a method according to the present invention to help dispersion to allow preparation of a homogenous coating formulation which can greatly improve uniformity of the coating on the foam. Suitable surfactants preferably include one or more nonionic surface active agents. A preferred class of nonionic surfactants includes alkoxylated alcohols, such as, for example, Brij® 30 and Brij® 76 available from Fisher Scientific, and more preferably, octylphenol ethoxylates, such as, for example, TRITON® X-series and GR-series surfactants commercially available from Union Carbide Co., as well as other alkoxylated surface active species such as alkoxylated fatty acid esters, including for example, Tween®20 and Tween®80, available from e.g., Cayman Chemical.

A defoamer can be included in a coating formulation for use in a method according to the present invention to help minimize the generation of foam in the formulation to further improve uniformity in the resulting coating. Preferred defoamers include nonionic defoamers. Preferably, a nonionic silicone defoamer is used. Suitable preferred nonionic silicone defoamers include one or more polysiloxanes, such as, for example, Byk® 20 and Byk® 80 and mixtures thereof available from Byk Chemie.

In various preferred embodiments, the binder, thickener, surfactant and defoamer are non-ionic. The particle to binder ratio ranges from 2:1 to 4:1. The order of addition is titanium dioxide particles, water, ammonium hydroxide, defoamer, surfactant, binder and then the thickener.

In various embodiments according to the present invention, a coating formulation, based on 100 parts titanium dioxide, can contain 600-1000 parts water, 0-10 parts ammonium hydroxide, 1-40 parts defoamer, 1-40 parts surfactant, 200-400 parts binder, and 0-100 parts thickener, preferably where one or more, and more preferably all, of the binder, defoamer, thickener and surfactant are nonionic. Optionally, other additives may be incorporated into a coating formulation in accordance with the various embodiments of the invention. Suitable optional additives can include, but are not limited to, anti-static agents, fire retardants, stabilizers, antimicrobial compounds, extender oils, dyes and pigments. Any such optional additive, if included, should not have a detrimental effect on the properties of the coated product.

After immersing the open cell foam in the mixture, the foam is removed from the mixture and any excess mixture is removed. In one embodiment of a method of producing an absorbent/filter material according to the present invention, a non-aqueous polyurethane binder is included in the mixture and after removing excess mixture from the foam, an additional reticulation step is carried out to partially remove the polyurethane binder.

One embodiment of a method for coating the open cell foam with photocatalytic titanium dioxide includes immersing the foam in a liquid mixture or slurry which comprises an aqueous mixture of photocatalytic grade titanium dioxide and an aqueous binder. The wetted foam is then compressed between a pair of nip rollers such that excess liquid or slurry is squeezed out of the wetted foam and collected for recycling into the impregnating process. The immersion and compression may be repeated two or more times to achieve a desired level of photocatalytic titanium dioxide loading in the open cell foam. The impregnated foam can then be dried, for example, in open air or in an oven. A suitable example of drying conditions for the impregnated foam is placing the impregnated foam in an oven at 200° C. for approximately ten minutes.

The foam product may be further shaped by various methods known to persons skilled in the art, including slicing, die cutting, grinding, peeling, machining, convoluting, embossing, laser cutting, water pressure cutting or other shaping by cutting or any combination of these techniques, to form a shaped part.

The present invention also includes methods of treating substances to destroy or decompose contaminants contained in the substances. Methods in accordance with such embodiments of the invention include passing a substance to be treated through an open cell foam which is at least partially coated with photocatalytic titanium dioxide such that the substance contacts the photocatalytic titanium dioxide, wherein the photocatalytic titanium dioxide has been activated by a source of UV radiation.

As used herein, “activated” and derivative words refer to the generation of one or more oxidizing species, such as a hydroxyl radical and/or a superoxide anion from the titanium dioxide by UV inducement of electron and/or hole activity in the titanium dioxide.

UV radiation sources which can be used in accordance with various methods of the present invention include, but are not limited to, UV lamps and sunlight. The source of UV radiation employed in any of the methods of the present invention can be separate or may be integral to a container or other apparatus holding the absorbent/filter material, such as, for example, a filter housing having a UV lamp affixed therein and enclosing a filter material in accordance with any of the various embodiments described above.

Substances which can be treated according to various methods of the present invention include liquids and gases, such as, for example, air and water.

Contaminants which can be destroyed or decomposed from the liquids and/or gases to be treated include, but are not limited to bacteria, pathogens, cigarette smoke ingredients, and volatile organic compounds. Coated articles in accordance with various embodiments of the invention can be said to have a “self-cleaning” capacity by which various contaminants on the article's surface are destroyed, decomposed or otherwise removed by the article's coating.

The present invention will now be illustrated in more detail by reference to the following specific, non-limiting examples.

### EXAMPLES

### Example 1

A 1.8 lb/ft³ reticulated polyurethane foam was coated with an aqueous binder containing a nanoparticulate anatase TiO₂. The coating formulation used is shown below in Table 1

TABLE 1
Coating formulation for TiO₂ particles

| Ingredient | Weight (parts) | Weight (%) |
|---|---|---|
| TiO₂ P-25 | 50 | 9.3 |
| Water | 400 | 74 |
| 10% NH₄OH | 2.5 | 0.5 |
| BYK 020 (defoamer) | 10 | 1.9 |
| 50% Triton X-155 (surfactant) | 10 | 1.9 |
| RHOPLEX E-358 (binder) | 41.5 | 7.7 |
| Acrysol RM-6000 (thickener) | 25 | 4.6 |

After the excess binder was removed and water dried off, the sample was measured to have a 33% TiO₂ pickup. As used herein, “TiO₂ pickup” refers to the percentage by weight of material added to the substrate (based on the original substrate weight) during the coating process which comprises titania. Thus, in this example, the foam gained 50% by weight during the coating process, going from 1.8 lb/ft³ to 2.7 lb/ft³, and approximately two-thirds of the added weight comprised TiO₂ (based on the coating formulation in Table 1 above with a 60% solids binder, Rhoplex E-358), providing 33% TiO₂ pickup.

The coated foam was then placed in an aqueous blue dye solution with no agitation, where the blue dye concentration was approximately 0.01 molar. The TiO₂ was subsequently activated by exposure to a UV lamp in a Weather-o-meter for 2 hours. The decomposition of the blue dye chemical was followed by measuring the UV absorbance of the solution, which is roughly proportional to the concentration of the dye. As shown in Table 2 below, a half life of 18 minutes was achieved. A 100% TiO₂ pickup sample was prepared in a manner similar to that described above and under similar testing conditions, a half life of 5 minutes was achieved. TiO₂ pickup can be adjusted by manipulating the nip roll pressure and gap such that more or less of the coating formulation remains with the foam.

TABLE 2
Dye Concentration as Indicated by UV Absorbance

| | | Dye Concentration in | Dye Concentration |
|---|---|---|---|
| | Dye Concentration | 33% TiO2-pickup | in 100% |
| Time, | in Uncoated Foam | Foam | TiO2-pickup Foam |
| min | as a % of Original | as a % of Original | as a % of Original |
| 0 | 100 | 100 | 100 |
| 5 | 98 | 82 | 51 |
| 10 | 99 | 69 | 30 |
| 20 | 100 | 48 | 18 |
| 30 | 98 | 28 | 7 |
| 60 | 100 | 8 | 1 |

### Example 2

Reticulated, TiO₂-coated foam samples prepared according to Example 1 were exposed to 150 ppm of NEM, which represents a volatile organic compound, with no agitation. The half life was 78 and 64 minutes for the samples with 33% and 100% TiO₂ pickup, respectively, as indicated in Table 3 below. The half life in air was longer than in water since the contact was less frequent in the absence of agitation.

TABLE 3
NEM Concentration as Measured on GC

| | | Dye Concentration in | Dye Concentration |
|---|---|---|---|
| | Dye Concentration | 33% TiO2-pickup | in 100% |
| Time, | in Uncoated Foam | Foam | TiO2-pickup Foam |
| min | as a % of Original | as a % of Original | as a % of Original |
| 0 | 100 | 100 | 100 |
| 15 | 101 | 83 | 79 |
| 30 | 102 | 77 | 66 |
| 60 | 100 | 59 | 51 |
| 120 | 101 | 40 | 38 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A filter or absorbent material comprising an open cell foam having a surface, wherein the surface of the open cell foam is at least partially coated with a layer comprising photocatalytic titanium dioxide.

2. The material according to claim 1, wherein the layer coats at least 50% of the surface.

3. The material according to claim 1, wherein the layer coats at least 75% of the surface.

4. The material according to claim 1, wherein the layer comprises titanium dioxide having an anatase crystalline structure.

5. The material according to claim 1, wherein the layer comprises titanium dioxide having an anatase crystalline structure in an amount of 50% by weight based on total amount of titanium dioxide contained in the layer.

6. The material according to claim 5, wherein the layer coats at least 50% of the surface.

7. The material according to claim 5, wherein the layer coats at least 75% of the surface.

8. The material according to claim 1, wherein the photocatalytic titanium dioxide has an average particle size of less than about 100 nanometers.

9. The material according to claim 5, wherein the photocatalytic titanium dioxide has an average particle size of less than about 100 nanometers.

10. The material according to claim 1, wherein the open cell foam comprises a polyurethane.

11. The material according to claim 10, wherein the layer comprises titanium dioxide having an anatase crystalline structure.

12. The material according to claim 10, wherein the layer comprises titanium dioxide having an anatase crystalline structure in an amount of 50% by weight based on total amount of titanium dioxide contained in the layer.

13. The material according to claim 12, wherein the layer coats at least 50% of the surface.

14. The material according to claim 12, wherein the layer coats at least 75% of the surface.

15. The material according to claim 10, wherein the photocatalytic titanium dioxide has an average particle size of less than about 100 nanometers.

16. The material according to claim 12, wherein the photocatalytic titanium dioxide has an average particle size of less than about 100 nanometers.

17. A filter or absorbent material comprising a porous substrate having a surface, wherein at least 50% of the surface of the porous substrate is coated with a layer comprising photocatalytic titanium dioxide

18. A method of treating a gas or liquid, the method comprising providing a filter or absorbent material according to claim 1, and passing a substance to be treated selected from the group consisting of liquids, gases and mixtures thereof, through the filter or absorbent material such that the substance contacts the photocatalytic titanium dioxide, wherein the photocatalytic titanium dioxide is activated by a source of UV radiation.

19. The method according to claim 18, wherein the substance comprises air.

20. The method according to claim 18, wherein the substance comprises air containing one or more contaminants selected from the group consisting of bacteria, volatile organic compounds, cigarette smoke and mixtures thereof.

21. The method according to claim 18, wherein the source of UV radiation comprises a UV lamp.

22. A method of preparing a filter or absorbent material, the method comprising: (a) providing a mixture comprising photocatalytic titanium dioxide in a binder; (b) immersing an open cell foam article in the mixture; (c) removing the article from the mixture and removing excess mixture from the article.

23. The method according to claim 22, wherein the binder comprises an aqueous acrylic composition.

24. The method according to claim 23, wherein the method further comprises reticulating the coated material such that the non-aqueous polyurethane binder is partially removed.

25. The method according to claim 22, wherein the open cell foam comprises a polyurethane.

26. The method according to claim 25, wherein the binder comprises an aqueous acrylic composition.

27. The method according to claim 26, wherein the method further comprises reticulating the coated material such that the non-aqueous polyurethane binder is partially removed.
